(19) United States
(12) Patent Application Publication
(10) Pub. No.: US 2011/0123301 A1
(43) Pub. Date: May 26, 2011

(54) BULK FEEDING STORAGE DEVICES TO STORAGE DEVICE TESTING SYSTEMS

(76) Inventors: Scott Noble, Denver, CO (US); Edward Garcia, Holbrook, MA (US); Evgeny Polyakov, Harvard, MA (US); Eric L. Truebenbach, Sudbury, MA (US); Brian S. Merrow, Harvard, MA (US)

(21) Appl. No.: 12/988,279

(22) PCT Filed: Apr. 16, 2009
(86) PCT No.: PCT/US09/40796

§ 371 Date: Feb. 2, 2011

Related U.S. Application Data
(63) Continuation-in-part of application No. 12/104,869, filed on Apr. 17, 2008.

(51) Int. Cl. B25J 9/00; B65G 1/04

(52) U.S. Cl. 414/222.13; 414/800; 414/589

(57) ABSTRACT

A method of supplying storage devices to a storage device testing system includes placing a storage device tote, carrying multiple storage devices, in a presentation position accessible to an automated transporter of the storage device testing system. The method includes actuating the automated transporter to retrieve one of the storage devices from the storage device tote, and actuating the automated transporter to deliver the retrieved storage device to a test slot of the storage device testing system and insert the storage device in the test slot.

### TECHNICAL FIELD

This disclosure relates to bulk feeding storage devices to storage device testing systems and transfer stations for storage device testing systems.

### BACKGROUND

Disk drive manufacturers typically test manufactured disk drives for compliance with a collection of requirements. Test equipment and techniques exist for testing large numbers of disk drives serially or in parallel. Manufacturers tend to test large numbers of disk drives simultaneously in batches. Disk drive testing systems typically include one or more racks having multiple test slots that receive disk drives for testing.

The testing environment immediately around the disk drive is closely regulated. Minimum temperature fluctuations in the testing environment are critical for accurate test conditions and for safety of the disk drives. The latest generations of disk drives, which have higher capacities, faster rotational speeds and smaller head clearance, are more sensitive to vibration. Excess vibration can affect the reliability of test results and the integrity of electrical connections. Under test conditions, the drives themselves can propagate vibrations through supporting structures or fixtures to adjacent units. This vibration “cross-talking,” together with external sources of vibration, contributes to bump errors, head slap and non-repetitive run-out (NRRO), which may result in lower test yields and increased manufacturing costs.

Current disk drive testing systems use an operator, a robotic arm, or a conveyer belt to individually feed disk drives to a transfer location for loading into the testing system for testing. A robotic arm of the testing system individually retrieves the disk drives from the transfer location and loads them in test slots for testing.

### SUMMARY

In one aspect, a method of supplying storage devices to a storage device testing system includes placing a storage device tote, carrying multiple storage devices, in a presentation position accessible to an automated transporter (e.g. robotic arm, gantry system, or multi-axis linear actuator) of the storage device testing system. The method includes actuating the robotic arm to retrieve one of the storage devices from the storage device tote, and actuating the automated transporter to deliver the retrieved storage device to a test slot of the storage device testing system and insert the storage device in the test slot.

Implementations of this aspect of the disclosure may include one or more of the following features. In some implementations, the method includes actuating the automated transporter to retrieve a storage device transporter, actuating the automated transporter to retrieve one of the storage devices from the storage device tote by using the storage device transporter to carry the storage device, and actuating the automated transporter to deliver the storage device transporter carrying storage device to the test slot. The automated transporter can retrieve the storage device from the storage device tote with the storage device transporter by positioning the storage device transporter below the storage device, lifting the storage device off a storage device support of the storage device tote, and carrying the storage device in the storage device transporter away from the storage device tote. When the storage device transporter, carrying the storage device, is inserted into the test slot, the storage device engages with a connector of the storage device testing system, and the storage device transporter provides closure of the test slot.

In some implementations, placing the storage device tote in the presentation position includes placing the storage device tote in a loading position on a transfer station, and actuating the transfer station to move the storage device tote from the loading position to the presentation position for servicing by the automated transporter. The transfer station includes a transfer station housing and multiple tote presentation support systems disposed on the transfer station housing. Each tote presentation support system is configured to receive and support a storage device tote in the presentation position for servicing by the storage device testing system (e.g. by the robotic arm). A tote mover, disposed on the transfer station housing, moves a loaded storage device tote between the loading position and the presentation position at one of the tote presentation support systems. In some examples, the method includes reading a tote marking on the storage device tote and actuating the transfer station (e.g. actuating the tote mover) to move the storage device tote from the loading position to the presentation position based on the tote marking. The tote marking can be a barcode, a color marking, or any suitable general or unique identifier. The method may include assigning the storage device tote a function property (e.g. “good output” storage device tote, “bad output” storage device tote, or “input” storage device tote) that affects the usage of the storage device tote in the storage device testing system. The function property is dynamically re-assignable during usage of the storage device tote in the storage device testing system.

In some implementations, the storage device tote placed in the presentation position is held in the presentation position by a transfer station configured to hold multiple storage device totes in the presentation position for servicing by the automated transporter. The storage device tote is supported in the presentation position by a tote presentation support system. In some examples, the tote presentation support system includes first and second opposing pairs of tote support arms configured to be received by respective arm grooves defined by a tote body of the storage device tote.

In another aspect, a method of supplying storage devices to a storage device testing system includes loading multiple storage devices into a storage device tote, placing the storage device tote in a loading position on a transfer station, and actuating a tote mover of the transfer station to move the storage device tote from the loading position to a presentation position for servicing by the storage device testing system.

Implementations of this aspect of the disclosure may include one or more of the following features. In some implementations, the storage device tote is supported in the presentation position by one of multiple tote presentation support systems disposed on a transfer station housing of the transfer station. The tote presentation support systems can be arranged vertically with respect to each other. In some examples, the tote presentation support system includes first and second opposing pairs of tote support arms configured to be received by respective arm grooves defined by a tote body of the storage device tote. The arm grooves can be releasably locked into a predetermined position on the tote support arms, thereby holding the respective storage device tote in its presentation position.

In some implementations, the method includes loading multiple storage device totes, each housing storage devices, onto the transfer station by sequentially placing each storage device tote in the loading position on the transfer station and actuating the tote mover to move each storage device tote to the presentation position at one of the multiple tote presentation support systems for servicing by the storage device testing system. In some examples, the method includes reading a tote marking on the storage device tote and actuating the transfer station (e.g. actuating the tote mover) to move the storage device tote from the loading position to the presentation position at one of the tote presentation support systems based on the tote marking. The tote marking can be a barcode, a color marking, or any suitable general or unique identifier. The method may include assigning the storage device tote a function property that affects the usage of the storage device tote in the storage device testing system. The function property is dynamically re-assignable during usage of the storage device tote in the storage device testing system.

In some examples, the transfer station includes a door pivotally attached to its transfer station housing. The door is operable to receive and support a storage device tote and provides closure of a tote supply opening defined by the transfer station housing. The method may include opening the door to an open position, placing the storage device tote in a preloading position on the door, and closing the door by rotating the door to a closed position, thereby placing the storage device tote in the loading position.

In some implementations, the tote mover includes a multi-axis actuator assembly configured to move the storage device tote between the loading position and the presentation position. The multi-axis actuator assembly may include a vertical actuator, a horizontal actuator, and a pitch actuator. Preferably, the multi-axis actuator assembly includes first, second, and third linear actuators. The first linear actuator is disposed on a side wall of the transfer station housing. A lift carriage is coupled to the first linear actuator. The second linear actuator is disposed on the lift carriage and is pivotally coupled to a tote loading support, which is configured to support at least one storage device tote. The tote loading support is operable to rotate between the loading and presentation positions. The third linear actuator is pivotally coupled to both the second linear actuator and the tote loading support. The third linear actuator is operable to rotate the tote loading support. The storage device tote includes a tote body that defines multiple storage device receptacles configured to each house a storage device.

In yet another aspect, a transfer station for a storage device testing system includes a transfer station housing and multiple tote presentation support systems disposed on the transfer station housing. Each tote presentation support system is configured to receive and support a storage device tote in a presentation position for servicing by the storage device testing system. A tote mover is disposed on the transfer station housing and is configured to move a storage device tote between a loading position and the presentation position at one of the tote presentation support systems. The tote mover, in some examples, includes a multi-axis actuator assembly having a vertical actuator, a horizontal actuator, and a pitch actuator.

Implementations of this aspect of the disclosure may include one or more of the following features. In some implementations, the transfer station includes a door pivotally attached to the transfer station housing and configured to provide closure of a tote supply opening defined by the transfer station housing. The door pivots between an open position, for receiving and supporting a storage device tote, and a closed position, for placing the storage device tote in the loading position. In some examples, the tote presentation support system includes first and second opposing pairs of tote support arms configured to be received by respective arm grooves defined by a tote body of a storage device tote.

In another aspect, a transfer station for a storage device testing system includes a transfer station housing and multiple tote presentation support systems disposed on the transfer station housing. Each tote presentation support system is configured to receive and support a storage device tote in a presentation position for servicing by the storage device testing system. The transfer station includes a tote mover disposed on the transfer station housing and a tote loading support pivotally coupled to the tote mover. The tote loading support pivots and moves between first and second positions, and is configured to receive and support a storage device tote. The tote mover is configured to move the tote loading support between the first position, for supporting a storage device tote in a loading position, and the second position, for supporting a storage device tote in the presentation position at one of the tote presentation support systems.

Implementations of this aspect of the disclosure may include one or more of the following features. In some implementations, the tote mover includes a multi-axis actuator assembly, which preferably includes a vertical actuator, a horizontal actuator, and a pitch actuator. In some examples, the multi-axis actuator assembly includes first, second, and third linear actuators. The first linear actuator is disposed on a side wall of the transfer station housing. A lift carriage is coupled to the first linear actuator. The second linear actuator is disposed on the lift carriage and pivotally coupled to the tote loading support, which pivots between the first and second positions. The third linear actuator is pivotally coupled to both the second linear actuator and the tote loading support. The third linear actuator is operable to rotate the tote loading support. In some examples, the first position of the tote loading support is substantially horizontal and the second position of the tote loading support is substantially vertical.

The transfer station may include a staging platform disposed on the transfer station housing and configured to receive a storage device tote transferred from the tote loading support. The staging platform is disposed on an opposite side of the transfer station housing of at least one of the tote presentation support systems. The transfer station may include a door pivotally attached to the transfer station housing and configured to provide a closure over the staging platform while in a closed position.

In some examples, the transfer station includes a door pivotally attached to the transfer station housing and configured to provide closure of a tote supply opening defined by the transfer station housing. The door is operable to pivot between an open position, for receiving and supporting a storage device tote, and a closed position, for placing the storage device tote in the loading position.

The tote presentation support systems can be disposed on the same side of the transfer station housing and arranged vertically with respect to each other. Each tote presentation support systems has a different elevation with respect to the others. The tote presentation support system, in some examples, includes first and second opposing pairs of tote support arms configured to be received by respective arm grooves defined by a tote body of a storage device tote. The storage device tote includes a tote body which defines multiple storage device receptacles configured to each house a storage device.

In another aspect, a storage device testing system includes an automated transporter and multiple racks arranged around the automated transporter for access by the automated transporter. Each rack houses multiple test slots, which are each configured to receive a storage device for testing. The storage device testing system includes a transfer station arranged for access by the automated transporter. The transfer station includes a transfer station housing and multiple tote presentation support systems disposed on the transfer station housing. Each tote presentation support system is configured to receive and support a storage device tote in a presentation position for servicing by the storage device testing system. A tote mover is disposed on the transfer station housing and is configured to move a storage device tote between a loading position and the presentation position at one of the tote presentation support systems. The tote mover, in some examples, includes a multi-axis actuator assembly having a vertical actuator, a horizontal actuator, and a pitch actuator. The tote presentation support system, in some examples, includes first and second opposing pairs of tote support arms configured to be received by respective arm grooves defined by a tote body of a storage device tote. In some examples, the tote mover includes first, second, and third linear actuators. The first linear actuator is disposed on a side wall of the transfer station housing. A lift carriage is coupled to the first linear actuator. The second linear actuator is disposed on the lift carriage and pivotally coupled to the tote loading support, which pivots between the first and second positions. The third linear actuator is pivotally coupled to both the second linear actuator and the tote loading support. The third linear actuator is operable to rotate the tote loading support. In some examples, the transfer station includes a marking reader configured to read a tote marking on a received storage device tote, the tote mover being configured to move the received storage device tote between the loading position and the presentation position at one of the tote presentation support systems based on the marking read by the marking reader.

The details of one or more implementations of the disclosure are set forth in the accompanying drawings and the description below. Other features, objects, and advantages will be apparent from the description and drawings, and from the claims.

### DESCRIPTION OF DRAWINGS

FIG. 1 is a perspective view of a storage device testing system and a transfer station.

FIG. 2 is a top view of a storage device testing system and a transfer station.

FIG. 3 is a perspective view of a storage device testing system and a transfer station.

FIG. 4 is a perspective view of a storage device being inserted into a test slot of a storage device testing system.

FIG. 5 is a perspective view of a storage device transporter.

FIG. 6 is a perspective view of a storage device transporter carrying a storage device.

FIG. 7 is a bottom perspective view of a storage device transporter carrying a storage device.

FIG. 8 is a perspective view of a storage device tote in a loading position.

FIG. 9 is a perspective view of a storage device tote in a presentation position.

FIG. 10 is a perspective view of a transfer station.

FIG. 11 is a perspective view of a tote in a presentation position for placement on a tote presentation support system of a transfer station.

FIG. 12 is a front perspective view of a tote mover disposed on a transfer station.

FIG. 13 is a rear perspective view of the tote mover shown in FIG. 12.

FIG. 14 is a rear elevated perspective view of the tote mover shown in FIG. 12.

FIG. 15 is a rear perspective view of a transfer station having a staging platform and door.

FIG. 16 is a side view of a transfer station.

FIG. 17 is a font view of the transfer station shown in FIG. 16.

Like reference symbols in the various drawings indicate like elements.

### DETAILED DESCRIPTION

Bulk feeding of storage devices in a storage device testing system is advantageous over manual individual feeding of storage devices by providing increased through-put and efficiency of the storage device testing system, inter alia. As will be discussed in detail, presenting multiple storage device totes (also referred to as totes), which hold multiple storage devices, to a storage device testing system allows continual storage device testing, disk sorting amongst multiple storage device totes, minimal user intervention, and increased efficiency over current systems, inter alia. Bulk feeding of storage devices in storage device totes provides the advantage of shop floor flexibility (e.g. by providing the ability to easily redirect a storage device tote or a cart or trolley carrying storage device totes versus rerouting fixed conveyors). An operator can present a batch of drives (e.g. via the storage device tote) to the storage device testing system and then walk away to service another system. Bulk feeding of storage devices in storage device totes also allows automatic sorting of tested drives with the storage device totes, as will be discussed below.

A storage device, as used herein, includes disk drives, solid state drives, memory devices, and any device that requires asynchronous testing for validation. A disk drive is generally a non-volatile storage device which stores digitally encoded data on rapidly rotating platters with magnetic surfaces. A solid-state drive (SSD) is a data storage device that uses solid-state memory to store persistent data. An SSD using SRAM or DRAM (instead of flash memory) is often called a RAM-drive. The term solid-state generally distinguishes solid-state electronics from electromechanical devices.

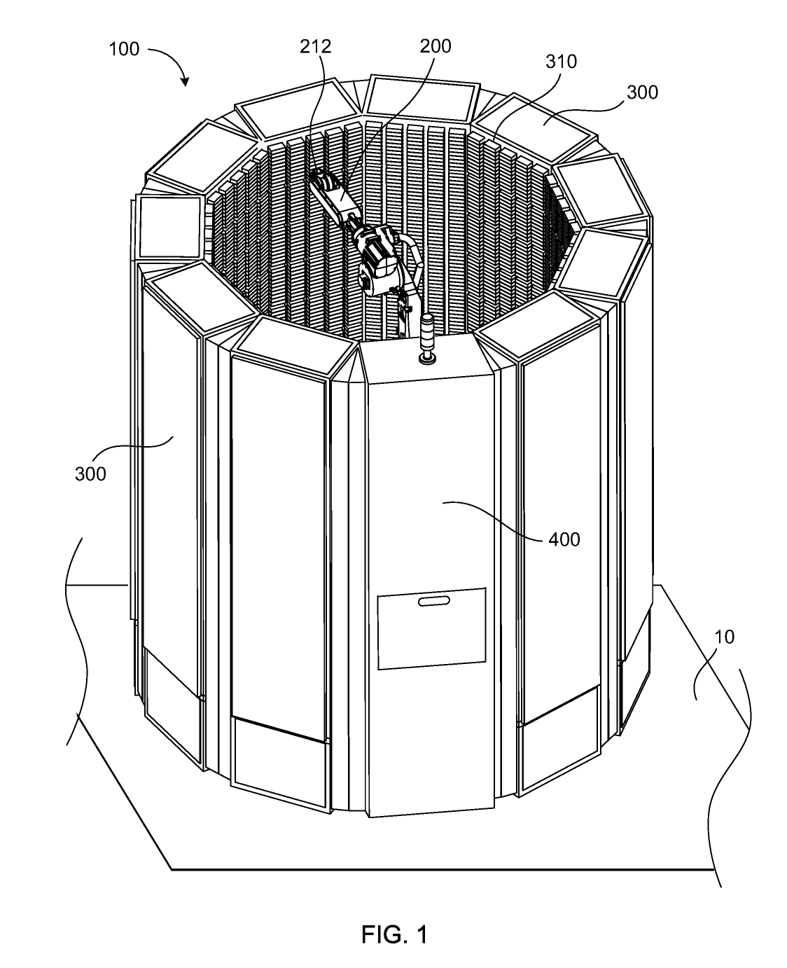

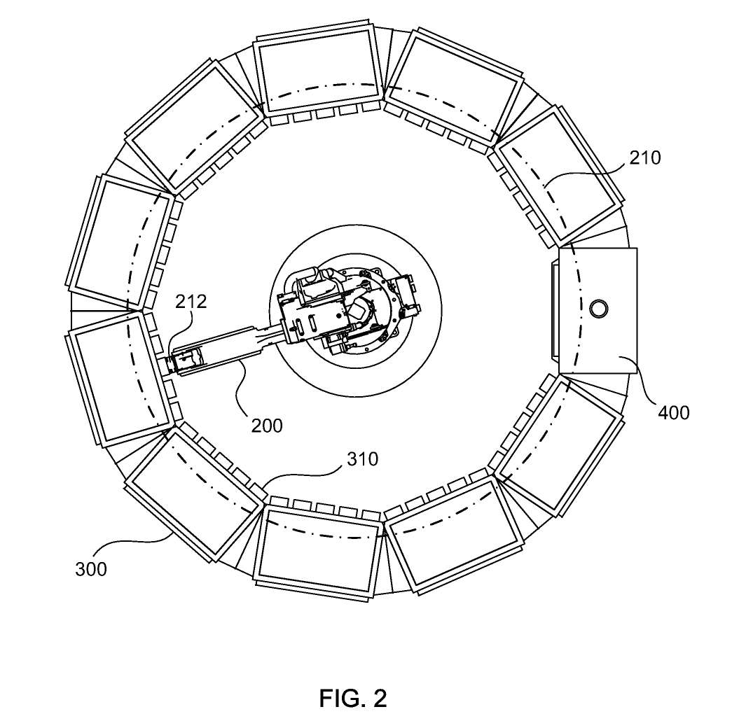

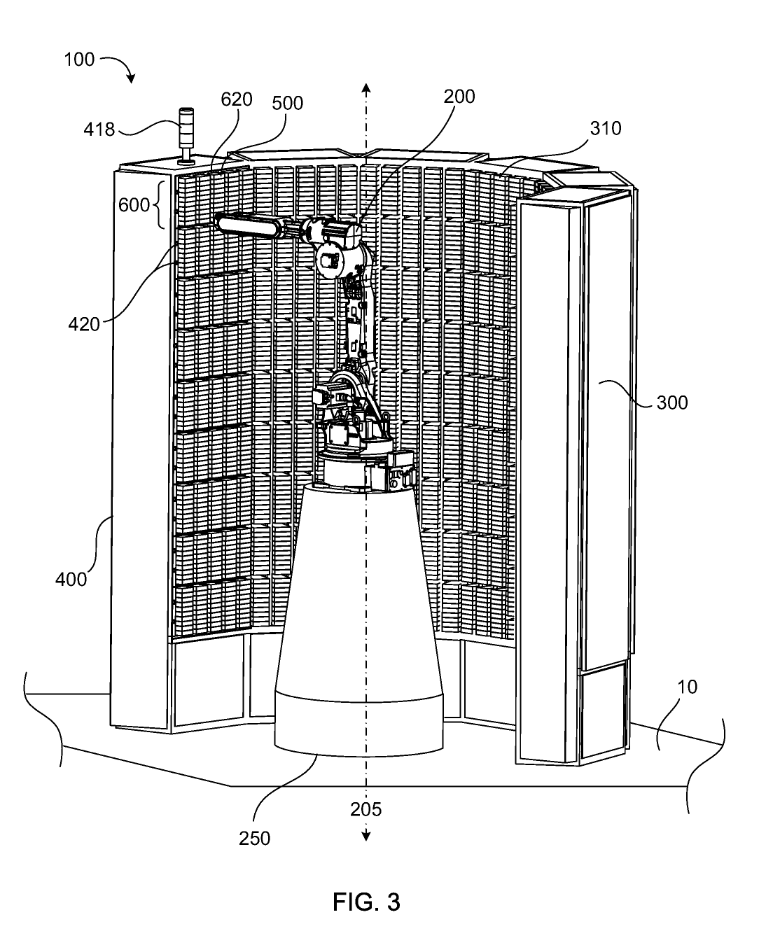

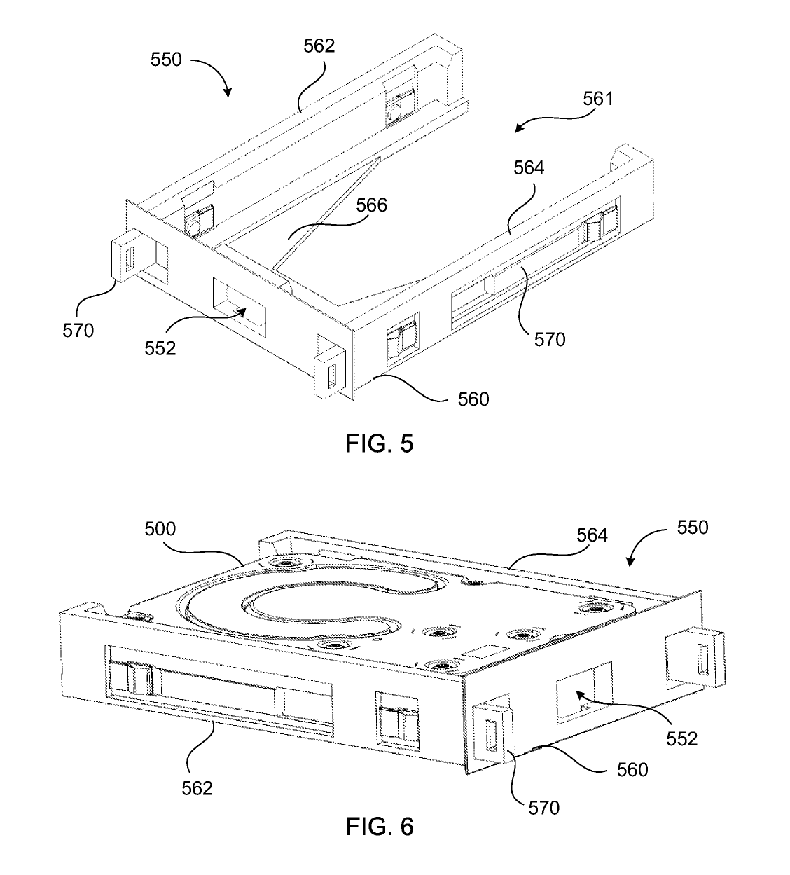

Referring to FIGS. 1-3, in some implementations, a storage device testing system 100 includes at least one automated transporter 200 (e.g. robotic arm, gantry system, or multi-axis linear actuator) defining a first axis 205 (see FIG. 3) substantially normal to a floor surface 10. In the examples shown, the automated transporter 200 comprises a robotic arm 200 operable to rotate through a predetermined arc about the first axis 205 and to extend radially from the first axis 205. The robotic arm 200 is operable to rotate 360° about the first axis 205 and includes a manipulator 212 disposed at a distal end of the robotic arm 200 to handle a storage device 500 and/or a storage device transporter 550 carrying the storage device 500 (see e.g. FIGS. 5-6). Multiple racks 300 are arranged around the robotic arm 200 for servicing by the robotic arm 200. Each rack 300 houses multiple test slots 310 configured to receive storage devices 500 for testing. The robotic arm 200 defines a substantially cylindrical working envelope volume 210, with the racks 300 being arranged within the working envelope 210 for accessibility of each test slot 310 for servicing by the robotic arm 200. The substantially cylindrical working envelope volume 210 provides a compact footprint and is generally only limited in capacity by height constraints. In some examples, the robotic arm 200 is elevated by and supported on a pedestal or lift 250 on the floor surface 10. The pedestal or lift 250 increases the size of the working envelope volume 210 by allowing the robotic arm 200 to reach not only upwardly, but also downwardly to service test slots 310. The size of the working envelope volume 210 can be further increased by adding a vertical actuator to the pedestal or lift 250.

The automated transporter 200 is configured to independently service each test slot 310 to provide a continuous flow of storage devices 500 through the testing system 100. A continuous flow of individual storage devices 500 through the testing system 100 allows random start and stop times for each storage device 500, whereas other systems that require batches of storage devices 500 to be run all at once as an entire testing loaded must all have the same start and end times. Therefore, with continuous flow, storage devices 500 of different capacities can be run at the same time and serviced (loaded/unloaded) as needed.

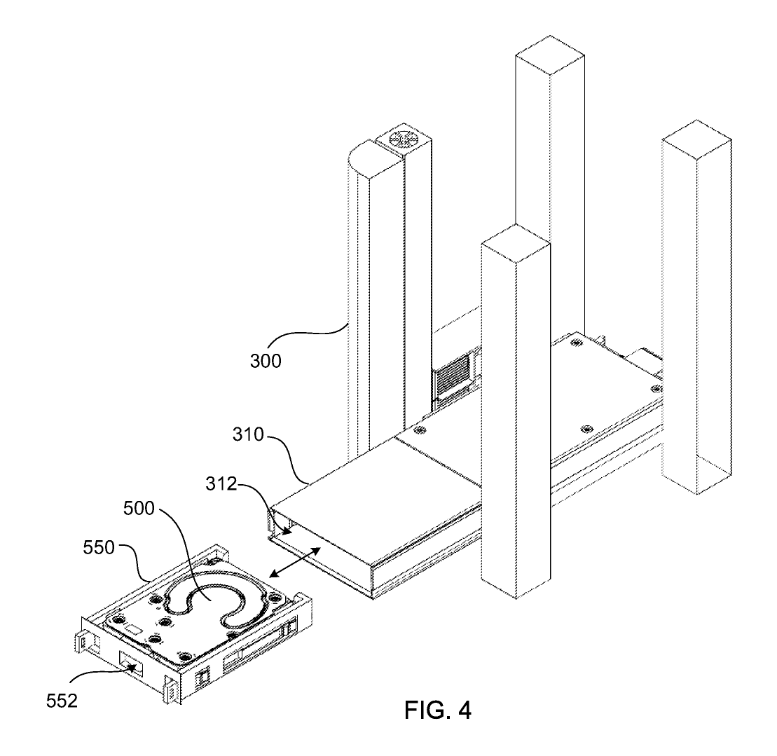

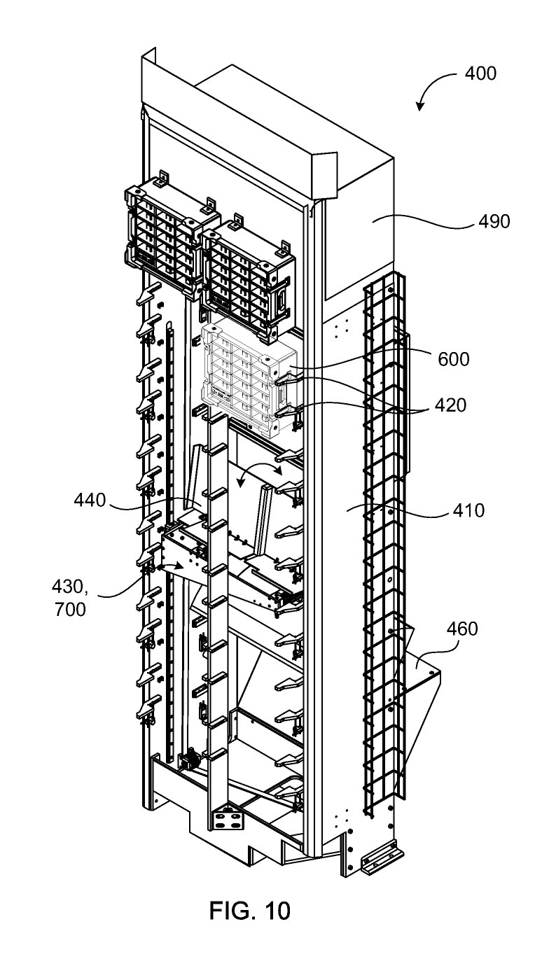

Referring to FIGS. 3-4, the storage device testing system 100 includes a transfer station 400 configured for bulk feeding of storage devices 500 to the automated transporter 200. The automated transporter 200 independently services each test slot 310 by transferring a storage device 500 between the transfer station 400 and the test slot 310. The transfer station 400 houses one or more totes 600 carrying multiple storage devices 500 presented for servicing by the automated transporter 200. The transfer station 400 is a service point for delivering and retrieving storage devices 500 to and from the storage device testing system 100. The totes 600 allow an operator to deliver and retrieve a collection of storage devices 500 to and from the transfer station 400. In the example shown in FIG. 3, each tote 600 is accessible from respective tote presentation support systems 420 in a presentation position and may be designated as a source tote 600 for supplying a collection of storage devices 500 for testing or as a destination tote 600 for receiving tested storage devices 500 (or both). Destination totes 600 may be classified as “passed return totes” or “failed return totes” for receiving respective storage devices 500 that have either passed or failed a functionality test, respectively. Each tote 600 may include a marking 660 (e.g. barcode, color mark, or unique identifier, such as a symbol) (see FIG. 9) that can be used to identify and categorize/classify the tote 600 and its contents. For example, the markings 660 on the totes 600 are barcodes, which has been assigned or associated with certain properties, such as “supply tote”, “passed return tote”, or “failed return tote”. When a tote 600 is loaded with untested storage devices 500, an operator or automated machine can read the barcode 660 with a barcode reader and associate the “supply tote” property with that tote, before it is loaded onto the transfer station 400. Similarly, an empty tote 600 can be associated with either the “passed return tote” or “failed return tote” property before it is loaded onto the transfer station 400. The marking property can be assigned or re-assigned at any time or point within the system.

Dynamic redefinition of the tote marking property provides a significant advantage of this system over manual systems (where the storage device totes are hung or placed in a particular location) or a carousel system (where each tier of a carousel typically contains one type of tote). Since the transfer station 400 provides a single input/output station for the storage device testing system 100, the location where the storage device totes 600 are loaded or unloaded becomes decoupled from the function of the storage device totes 600. Input storage device totes 600, good output storage device totes 600, and bad output storage device totes 600, are all loaded and unladed from the same place. In the cases where the storage device totes 600 do not have tote marking 660 with assigned tote marking properties (e.g. functions), the function 600 of the tote can change while the tote 600 is in the transfer station 400 or presented to the storage device testing system 100. For example, if all of the “good output” storage device totes 600 are filled by the automated transporter 200, but there are several empty “bad output” storage device totes 600 waiting idle, one or more of these storage device totes 600 can be reassigned (via the marking property association) to be a “good output” storage device totes 600. In another example, “input” storage device totes 600 can become one or the other type of “output” storage device totes 600 once they are emptied, thus saving the effort of removing them from the system and re-inserting a different type of storage device tote 600. This provides advantages for storage device testing system 100 with its single load/unload transfer station 400, because an operator has no assumptions about the functions of a storage device tote 600 based on its presentation position. When the transfer station 400 is requested to yield a “bad output” storage device tote 600, it will produce a “bad output” storage device tote 600, whether it started that way or not.

In implementations that employ storage device transporters 550 for manipulating storage devices 500, as shown in FIG. 4, the automated transporter 200 is configured to remove a storage device transporter 550 from one of the test slots 310 with the manipulator 212, then pick up a storage device 500 from one the totes 600 presented at the transfer station 400 with the storage device transporter 550, and then return the storage device transporter 550, with a storage device 500 therein, to the test slot 310 for testing of the storage device 500. After testing, the automated transporter 200 retrieves the tested storage device 500 from the test slot 310, by removing the storage device transporter 550 carrying the tested storage device 500 from the test slot 310 (i.e., with the manipulator 212), carrying the tested storage device 500 in the storage device transporter 550 to the transfer station 400, and manipulating the storage device transporter 550 to return the tested storage device 500 to one of the totes 600 at the transfer station 400.

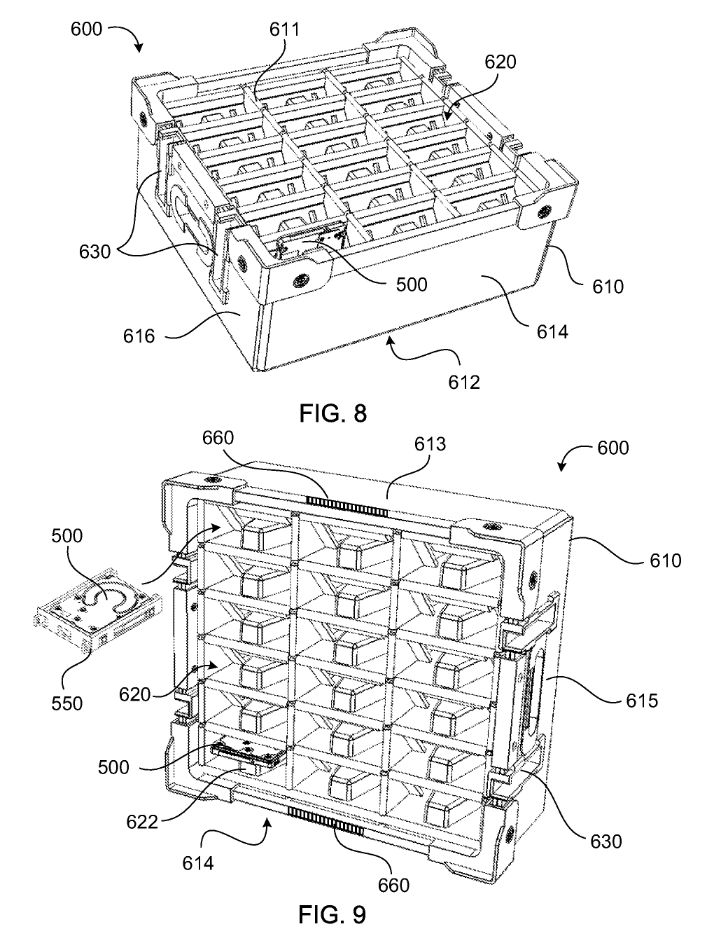

The test slot 310, shown in FIG. 4, defines an opening 312 configured to receive the storage device transporter 550, which in this case provides closure of the test slot 310. The storage device transporter 550 is configured to receive the storage device 500, as shown in FIG. 5, and be handled by the automated transporter 200. In use, one of the storage device transporters 550 is removed from one of the test slots 310 with the robot 200 (e.g., by grabbing, or otherwise engaging, the indentation 552 of the transporter 550 with the manipulator 212 of the robot 200). In some examples, as illustrated in FIGS. 5-7, the storage device transporter 550 includes a frame 560 defining a substantially U-shaped opening 561 formed by sidewalls 562, 564 and a base plate 566 that collectively allow the frame 560 to fit around a storage device support (not shown) in the tote 600 so that the storage device transporter 550 can be moved (e.g., via the robotic arm 200) into a position beneath one of the storage devices 500 housed in one of multiple storage device receptacles 620 defined by the tote 600 (see e.g., FIGS. 8-9). The storage device transporter 550 can then be raised (e.g., by the robotic arm 200) into a position engaging the storage device 600 for removal from the tote 600.

With the storage device 500 in place within the frame 560 of the storage device transporter 550, the storage device transporter 550 and the storage device 500 together can be moved by the automated transporter 200 for placement within one of the test slots 310, as shown in FIG. 4. In some implementations, the manipulator 212 is also configured to initiate actuation of a clamping mechanism 570 disposed in the storage device transporter 550. This allows actuation of the clamping mechanism 570 before the transporter 550 is moved from the tote 600 to the test slot 310 to inhibit movement of the storage device 500 relative to the storage device transporter 550 during the move. Prior to insertion in the test slot 310, the manipulator 212 can again actuate the clamping mechanism 570 to release the storage device 500 within the frame 560. This allows for insertion of the storage device transporter 550 into one of the test slots 310, until the storage device 500 is in a test position with a storage device connector 510 engaged with a test slot connector (not shown). The clamping mechanism 570 may also be configured to engage the test slot 310, once received therein, to inhibit movement of the storage device transporter 550 relative to the test slot 310. In such implementations, once the storage device 500 is in the test position, the clamping mechanism 570 is engaged again (e.g., by the manipulator 212) to inhibit movement of the storage device transporter 550 relative to the test slot 310. The clamping of the transporter 550 in this manner can help to reduce vibrations during testing. In some examples, after insertion, the storage device transporter 550 and storage device 500 carried therein are both clamped or secured in combination or individually within the test slot 310.

In the example illustrated in FIGS. 8-9, the tote 600 includes a tote body 610 having a front side 611, a back side 612, a top side 613, a bottom side 614, a right side 615 and a left side 616. The tote body 610 defines multiple storage device receptacles 620 in the front side 611 that are each configured to house a storage device 500. In some examples, the tote 600 rests on its back side 612 while in the loading position, such that the storage device receptacles 620 are substantially vertical and face upward, as shown in FIG. 8. In other examples, the tote 600 is held in another orientation while in the loading position, such as at an incline or in a vertical orientation, as with the presentation position. In the presentation position, the tote 600 rests on its bottom side 614, such that the storage device receptacles 620 are substantially horizontal and face laterally, as shown in FIG. 9. The tote body 610 defines arm grooves 630 in the right and left sides 615, 616 of the tote body 610 that are configured to support the tote 600. Other presentation positions are possible as well. The tote 600 can be held in an inclined position, while in the presentation position, such that any storage devices 500 housed in the storage device receptacles 620 slide to the back of the storage device receptacles 620. In some examples, the tote body 610 is configured such that the tote rests in an inclined position. In other examples, the storage device supports 622 hold the totes 600 at inclined positions, which in some cases may be variable (e.g. set by an adjustment screw, lever, or actuator).

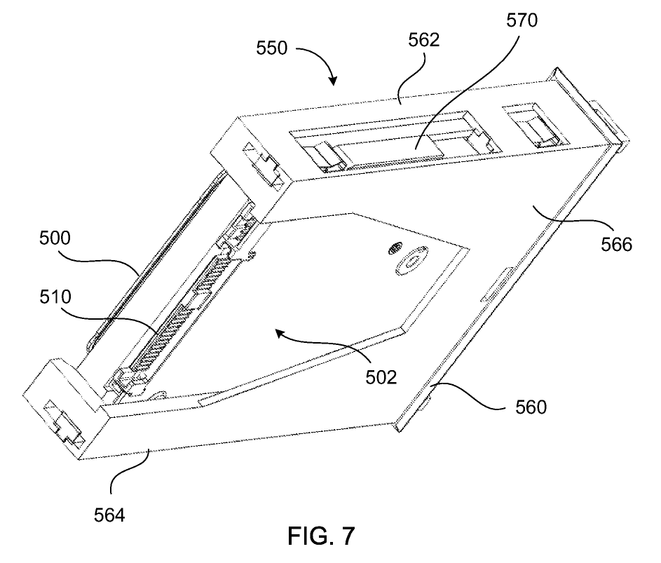

In the example shown, each storage device receptacle 620 includes a storage device support 622 configured to support a central portion 502 (see FIG. 7) of the received storage device 500 to allow manipulation of the storage device 500 along non-central portions. In some implementations, the storage device support 622 is configured to support the storage device 500 at an incline, while the tote 600 is in a substantially vertical orientation, such that the storage device 500 has a tending to slide deeper into the storage device receptacle 620, rather than out of the storage device receptacle 620, when the tote 600 is resting on its bottom side 614. To remove a housed storage device 500 from the storage device receptacle 620, the storage device transporter 550 is positioned below the storage device 500 (e.g. by the robotic arm 200) in the storage device receptacle 620 and elevated to lift the storage device 500 off of the storage device support 622. The storage device transporter 550 is then removed from the storage device receptacle 620 while carrying the storage device 500 for delivery to a destination target, such as a test slot 310.

Referring to FIG. 10, in some implementations, the transfer station 400 includes a transfer station housing 410 and multiple tote presentation support systems 420 disposed on the transfer station housing 410. Each tote presentation support system 420 is configured to receive and support a storage device tote 600 in a presentation position for servicing by the storage device testing system 100. In some examples, the tote presentation support systems 420 have adjustable spacing to accommodate different sizes of totes 600 or to present totes 600 at specific locations with respect to the automated transporter 200.

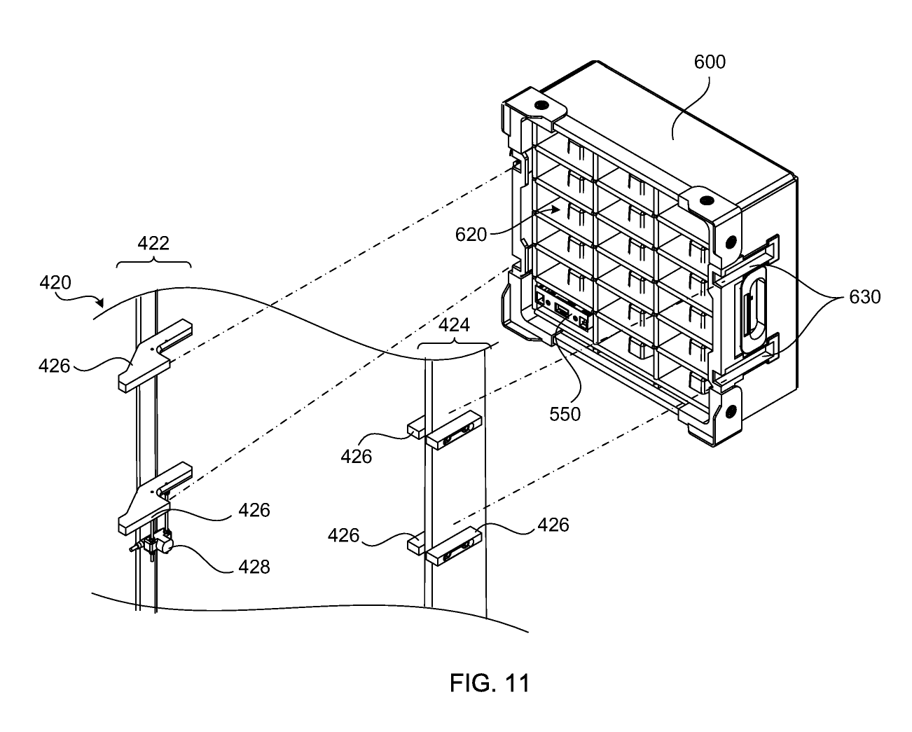

In some implementations, the tote presentation support systems 420 are each disposed on the same side of the transfer station housing 410 and arranged vertically with respect to each other. Each tote presentation support systems 420 has a different elevation with respect to the others. In some examples, as shown in FIG. 11, the tote presentation support system 420 includes first and second opposing pairs 422, 424 of tote support arms 426 configured to be received by respective arm grooves 630 defined by the tote body 610 of the storage device tote 600. The first and second pairs 422, 424 of tote support arms 426 are configured to key-in the respective tote 600 to a specific position, which can be known by the automated transporter 200. In one example, the tote 600 is moved (e.g. by the tote mover 430) horizontally onto the respective tote support arms 426, followed by an incremental movement down and out to set the arm grooves 630 of the tote 600 in the keyed presentation position on the respective tote support arms 426. Holding the tote 600 at a specific predetermined position allows the automated transporter 200 to access the tote 600 without knocking into the tote 600. In some implementations, the tote 600 is locked in place in the presentation position by a tote lock 428 (e.g. mechanical, pneumatic, or solenoid locking mechanism) disposed on the tote presentation support systems 420.

Referring again to FIG. 10, a tote mover 430 is disposed on the transfer station housing 410 and is configured to move a pivotally coupled tote loading support 440, which is configured to receive and support a storage device tote 600. The tote loading support 440 pivots and moves between a first position and a second position. The tote mover 430 is configured to move the tote loading support 440 between the first position, for holding a storage device tote 600 in a loading position (e.g. in a horizontal orientation at the loading support's first position), and the second position, for holding a storage device tote 600 in the presentation position (e.g. in a substantially vertical orientation) at one of the tote presentation support systems 420 for servicing by the storage device testing system 100 (e.g. by the robotic arm 200). In some examples, the tote presentation support system 420 holds the tote 600 at a slightly inclined (e.g. off vertical) orientation to keep storage devices 500 from accidentally slipping out of the tote 600. The tote mover 430 maximizes the available input of totes 600 presented to the storage device testing system 100. Furthermore, the tote mover 430 allows totes 600 to be delivered to the transfer station 400 at an ergonomic height and in an ergonomic position or manner (e.g. the loading position). The tote mover 430 then moves the totes 600 to their presentation positions, which are not necessarily accessible by or ergonomic for an operator, but are accessible by the automated transporter 200.

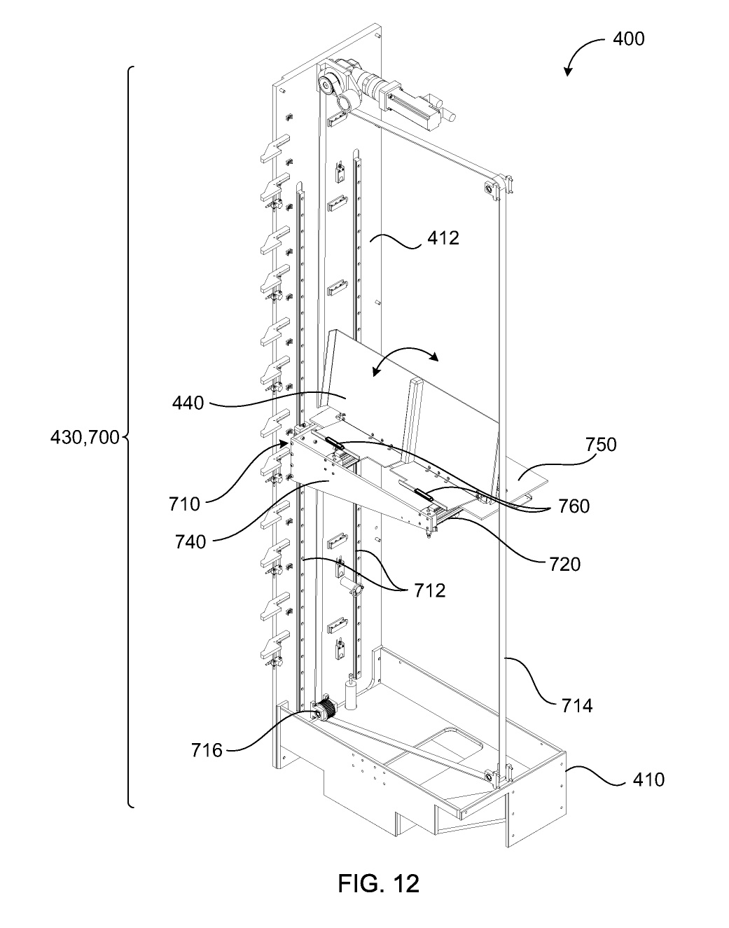

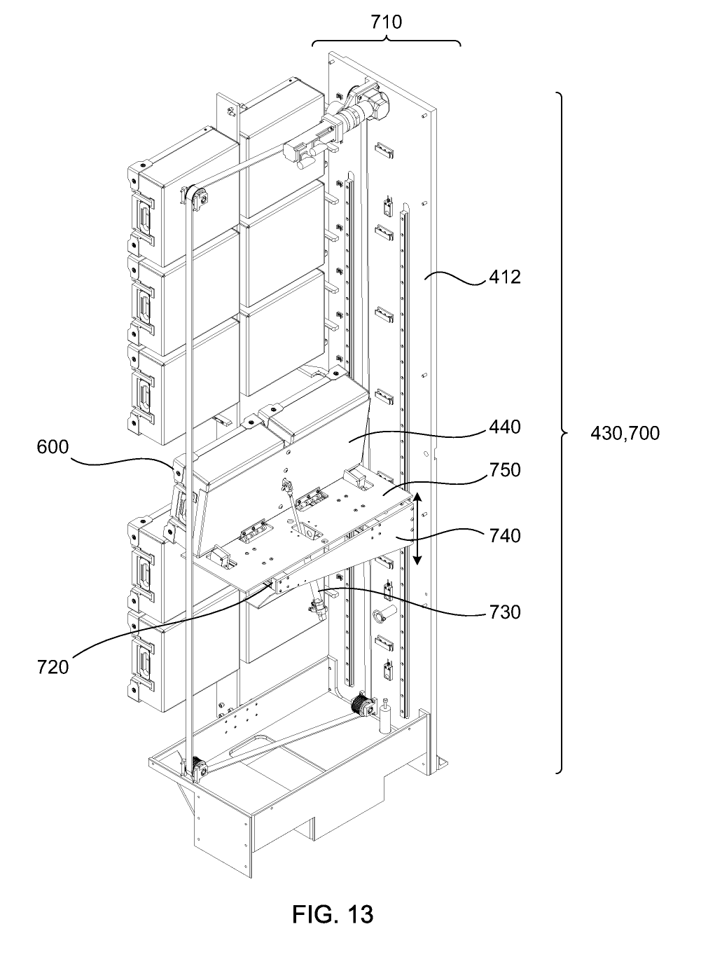

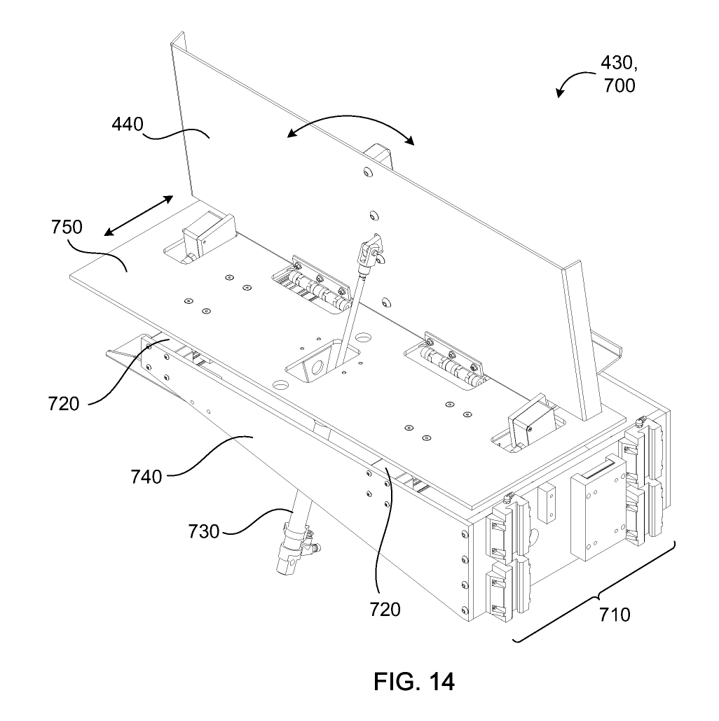

In some examples, as shown in FIGS. 12-14, the tote mover 430 includes a multi-axis actuator assembly 700 having a vertical actuator 710, a horizontal actuator 720, and a pitch actuator 730. The vertical actuator 710 is disposed on a side wall 412 of the transfer station housing 410 and controls an elevation of the tote loading support 440. A lift carriage 740 couples the vertical actuator 710 to the horizontal actuator 720, which controls a lateral position of the tote loading support 440. A lift table 750 is attached to the horizontal actuator 720, which may include a pair of linear actuators as shown. The tote loading support 440 is pivotally attached to both the horizontal actuator 720 (e.g. via the lift table 750) and the pitch actuator 730, which controls a pitch of the tote loading support 440. Each actuator 710, 720, 730 can be ball screw, hydraulic, or belt driven, among other suitable means of driving the actuators 710, 720, 730. In the example shown in FIG. 12, the vertical actuator 710 includes a slide guide 712 driven by a belt 714 via a coupled motor 716. After an operator places a storage device tote 600 on the tote loading support 440 in the loading position, the operator enables the tote mover 430 to move the storage device tote 600 to the presentation position at one of the tote presentation support systems 420. In some examples, the transfer station 400 houses a controller 490 (see FIGS. 10 & 15) in communication with the tote mover 430. The controller 490 directs the tote mover 430 to move the storage device tote 600 to the presentation position at a specific tote presentation support system 420 based on either a user input (e.g. via user interface allowing the operator to specify a destination tote presentation support system 420) or a program or control algorithm that monitors and allocates availability of tote presentation support systems 420. In some examples, the transfer station 400 includes a marking reader 760 (see FIG. 12), such as a barcode reader, disposed on the tote mover 430 (in the case shown, on the lift table 750) that reads the makings 660 on the totes 600 (e.g. while in the loading position) and moves the totes 600 to their respective presentation positions based on their marking properties. To move the storage device tote 600 to the presentation position at one of the tote presentation support systems 420, the vertical actuator 710 alters an elevation of the storage device tote 600 to coincide with an elevation of a destination tote presentation support system 420. The pitch actuator 730 alters a pitch of the tote loading support 440 to move a supported storage device tote 600 to the presentation position. The horizontal actuator 720, and optionally the vertical and pitch actuators 710, 730, moves the storage device tote 600 onto a destination tote presentation support system 420. Preferably, the pitch actuator 730 alters a pitch of the storage device tote 600 to move from the loading position to the presentation position before the vertical actuator 710 changes an elevation of the storage device tote 600 to coincide with an elevation of the destination tote presentation support system 420. The tote mover 430 can maintain a relatively smaller footprint while altering the elevation of the storage device tote 600 in a substantially vertical orientation. Preferably, the tote loading support 440 supports the storage device tote 600 at a slightly inclined (e.g. off vertical) orientation while moving the storage device tote 600, as to keep storage devices 500 from accidentally slipping out of the storage device tote 600. The actuators 710, 720, 730 cooperate in similar manner, but in reverse, to move the storage device tote 600 from the presentation position at one of the tote presentation support systems 420 back to the loading position for servicing by an operator.

In some implementations, the first position of the tote loading support 440 is substantially horizontal and the second position of the tote loading support 440 is substantially vertical. In other implementations, the first position of the tote loading support 440 is at an angle with a horizontal plane (e.g. to accommodate a particular ergonomic placement of the storage device tote 600).

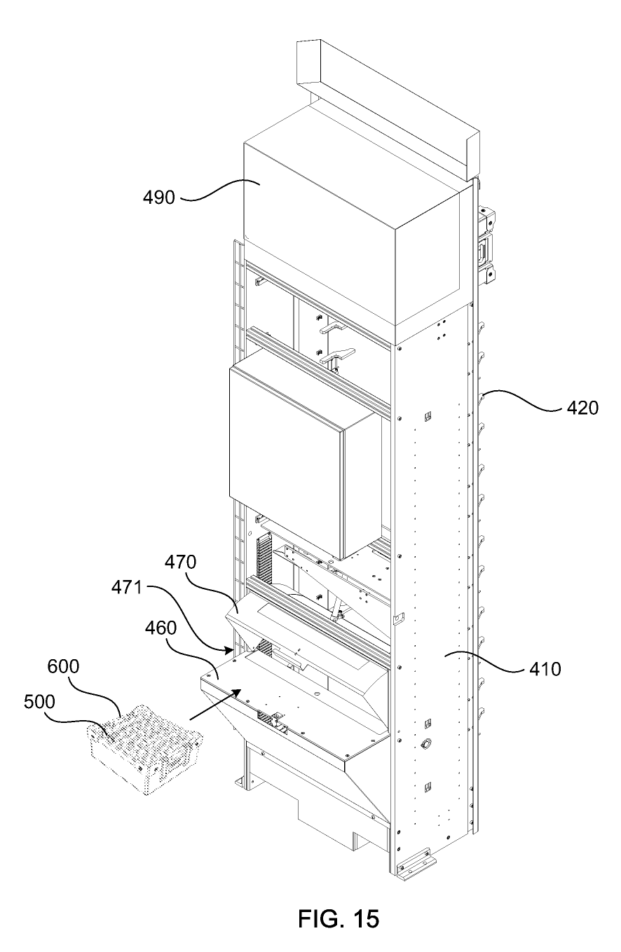

In some implementations, the transfer station 400 includes a staging platform 460, as shown in FIG. 15, disposed on the transfer station housing 410 and configured to receive a storage device tote 600 for transferring to and from the tote loading support 440. In the example shown, the staging platform 460 is disposed on an opposite side of the transfer station housing 410 of the tote presentation support systems 420. An operator may place or slide (e.g. from a cart) a storage device tote 600 carrying storage devices 550 onto the staging platform 460 and then move the storage device tote 600 onto the tote loading support 440 to the loading position. In some examples, the transfer station 400 includes a door 470 pivotally attached to the transfer station housing 410 and configured to provide a closure over the staging platform 460 and/or a tote supply opening 471 defined by the transfer station housing 410 while in a closed position. When the door 470 is in an open position, allowing access to the tote loading support 440, the tote mover 430 is disabled for safety reasons.

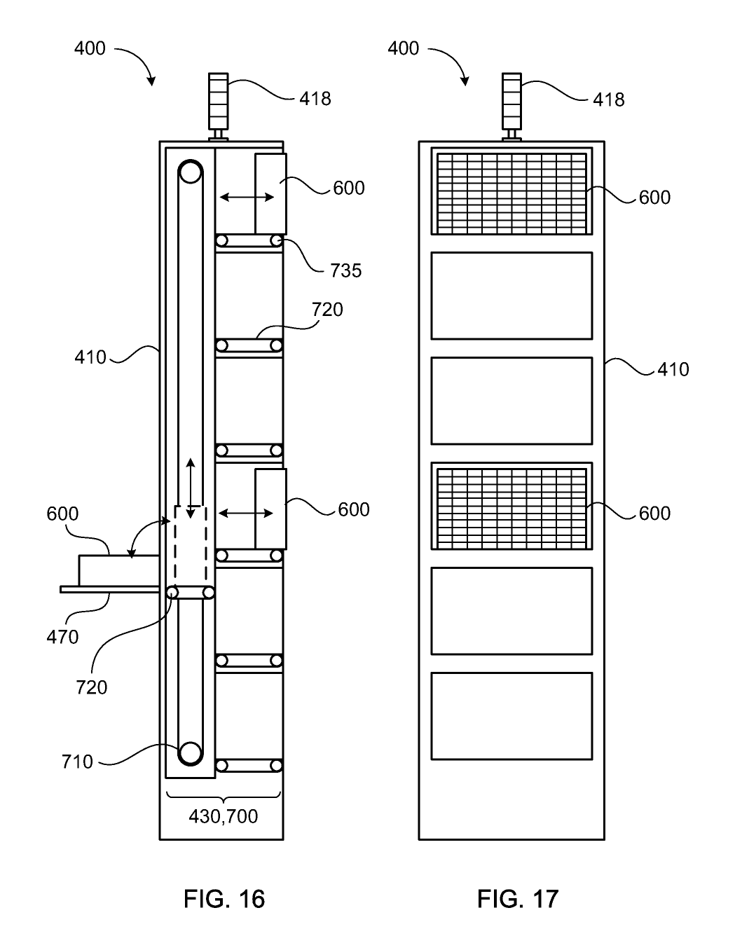

Referring to FIGS. 16-17, in some implementations, the transfer station 400 includes a tote mover 430 having a multi-axis actuator assembly 700 that includes a vertical actuator 710 and a horizontal actuator 720. In the example shown, the vertical actuator 710 is a belt driven lines actuator and the horizontal actuator 720 is a first conveyer belt assembly coupled to the vertical actuator 710. Each tote presentation support system 420 disposed on the transfer station housing 410 includes a presentation actuator 735 configured to receive and support a storage device tote 600 in a presentation position for servicing by the storage device testing system 100. The presentation actuator 735 is a second conveyer belt assembly. The transfer station 400 includes a door 470 pivotally attached to the transfer station housing 410 and operable to pivot between an open position, for receiving and supporting a storage device tote 600, and a closed position, for placing the storage device tote 600 in the loading position on the horizontal actuator 720. The tote mover 430 moves the storage device tote 600 to one of the tote presentation support systems 420. The horizontal actuator 720 advances the storage device tote 600 onto the presentation actuator 735, which moves the storage device tote 600 to the presentation position for servicing by the storage device testing system 100 (e.g. by the robotic arm 200).

In some examples, the transfer station 400 includes a station indicator 418 which provides visual, audible, or other recognizable indications of one or more states of the transfer station 400. In one example, the station indicator 418 includes lights (e.g. LEDs) that indicate when one or more totes 600 need servicing (e.g. to load/unload storage device totes 600 to/from the transfer station 400). In another example, the station indicator 418 includes one or more audio devices to provide one or more audible signals (e.g. chirps, clacks, etc.) to signal an operator to service the transfer station 400.

A method of performing storage device testing includes presenting multiple storage devices 500 to a storage device testing system 100 for testing and actuating an automated transporter 200 (e.g. robotic arm) to retrieve one of the storage devices 500 from the storage device tote 600 and deliver the retrieved storage device 500 to a test slot 310 of a rack 300 of the storage device testing system 100. The method includes actuating the automated transporter 200 to insert the storage device 500 in the test slot 310, and performing a functionality test on the storage device 500 received by the test slot 310. The method may also include actuating the automated transporter 200 to retrieve the tested storage device 500 from the test slot 310 and deliver the tested storage device 500 back to a destination location.

In retrieving one of the presented storage devices 500 for testing, the method preferably includes actuating the automated transporter 200 to retrieve a storage device transporter 550 (e.g. from a test slot 310 housed in a rack 300), and actuating the automated transporter 200 to retrieve one of the storage devices 500 from the transfer station 400 and carry the storage device 500 in the storage device transporter 550. The method includes actuating the automated transporter 200 to deliver the storage device transporter 550 carrying the storage device 500 to the test slot 310 for performing a functionality test on the storage device 500 housed by the received storage device transporter 550 and the test slot 310. In some examples, delivering the storage device transporter 550 to the test slot 310 includes inserting the storage device transporter 550 carrying the storage device 500 into the test slot 310 in the rack 300, establishing an electric connection between the storage device 500 and the rack 300. After testing is completed on the storage device 500, the method includes actuating the automated transporter 200 to retrieve the storage device transporter 550 carrying the tested storage device 500 from the test slot 310 and deliver the tested storage device 500 back to a destination location, such as a destination storage device tote 600 on the transfer station 400. In some implementations, the rack 300 and two or more associated test slots 310 are configured to move storage devices 500 internally from one test slot 310 to another test slot 310, in case the test slots 310 are provisioned for different kinds of tests.

In some examples, the method includes actuating the automated transporter 200 to deposit the storage device transporter 550 in the test slot 310 after depositing the tested storage device 500 at a destination location (e.g. in a storage device receptacle 620 of a destination storage device tote 600), or repeating the method by retrieving another storage device 500 for testing (e.g. from the storage device receptacle 620 of a source storage device tote 600).

A method of supplying or presenting storage devices 500 to the storage device testing system 100 includes loading multiple storage devices 500 into a storage device tote 600, placing the storage device tote 600 in the loading position on a transfer station 400, and actuating the tote mover 430 of the transfer station 400 to move the storage device tote 600 from the loading position to the presentation position for servicing by the storage device testing system 100. The storage device tote 600 is supported in the presentation position by one of multiple tote presentation support systems 420 disposed on the transfer station housing 410 and arranged vertically with respect to each other. Multiple storage device totes 600, each housing storage devices 500, can be sequentially placed in the loading position on the transfer station 400 and moved by the tote mover 430 to its respective presentation position at one of the multiple tote presentation support systems 420 for servicing by the storage device testing system 100.

In some examples, the method includes opening a door 470 pivotally attached to the transfer station housing 410 to an open position. The door 470 is configured to provide closure of a tote supply opening 471 defined by the transfer station housing 410 and is operable to receive and support the storage device tote 600. The method includes placing the storage device tote 600 in a preloading position on the door 470 and closing the door 470, by rotating the door 470 to a closed position, thereby placing the storage device tote 600 in the loading position.

A method of performing storage device testing includes placing a storage device tote 600 carrying multiple storage devices 500 in a loading position on a transfer station 400, actuating the transfer station 400 to move the storage device tote 600 from the loading position to a presentation position for servicing by an automated transporter 200. The method includes actuating the automated transporter 200 to retrieve one of the storage devices 500 from the storage device tote 600 and delivering the storage device 500 to a test slot 310. The method includes actuating the automated transporter 200 to insert the storage device 500 in the test slot 310, and performing a functionality test on the storage device 500 received by the test slot 310. The method may also include actuating the automated transporter 200 to retrieve the tested storage device 500 from the test slot 310 and deliver the tested storage device 500 back to the transfer station 400. In some examples, the method includes loading multiple storage device totes 600 carrying storage devices 500 onto the transfer station 400 by sequentially placing each storage device tote 600 in the loading position on the transfer station 400 and actuating the transfer station 400 to move each storage device tote 600 to a respective presentation position for servicing by the automated transporter 200. The method may include actuating the automated transporter 200 to retrieve a storage device transporter 550 (e.g. from the test slot 310), and retrieve and carry the storage device 500 in the storage device transporter 550 to deliver the storage device 500 to the test slot 310.

A number of implementations have been described. Nevertheless, it will be understood that various modifications may be made without departing from the spirit and scope of the disclosure. Accordingly, other implementations are within the scope of the following claims.

1. A method of supplying storage devices to a storage device testing system, the method comprising:
placing a storage device tote, carrying multiple storage devices, in a presentation position accessible to an automated transporter of the storage device testing system;
actuating the automated transporter to retrieve one of the storage devices from the storage device tote; and
actuating the automated transporter to deliver the retrieved storage device to a test slot of the storage device testing system and insert the storage device in the test slot.

2. The method of claim 1, further comprising:
actuating the automated transporter to retrieve a storage device transporter;
actuating the automated transporter to retrieve one of the storage devices from the storage device tote by using the storage device transporter to carry the storage device; and
actuating the automated transporter to deliver the storage device transporter carrying storage device to the test slot.

3. The method of claim 2, wherein the automated transporter retrieves the storage device from the storage device tote with the storage device transporter by positioning the storage device transporter below the storage device, lifting the storage device off a storage device support of the storage device tote, and carrying the storage device in the storage device transporter away from the storage device tote.

4. The method of claim 2, further comprising inserting the storage device transporter, carrying the storage device, into the test slot, engaging the storage device with a connector of the storage device testing system, and provides closure of the test slot.

5. The method of claim 1, wherein placing the storage device tote in the presentation position comprises:
placing the storage device tote in a loading position on a transfer station; and
actuating the transfer station to move the storage device tote from the loading position to the presentation position for servicing by the automated transporter.

6. A method of supplying storage devices to a storage device testing system, the method comprising:
loading multiple storage devices into a storage device tote;
placing the storage device tote in a loading position on a transfer station; and
actuating a tote mover of the transfer station to move the storage device tote from the loading position to a presentation position for servicing by the storage device testing system.

7. The method of claim 6, wherein the transfer station comprises:
a transfer station housing;
multiple tote presentation support systems disposed on the transfer station housing, each tote presentation support system being configured to receive and support a storage device tote in the presentation position for servicing by the storage device testing system; and
a tote mover disposed on the transfer station housing and configured to move a storage device tote between the loading position and the presentation position at one of the tote presentation support systems.

8. The method of claim 6, further comprising supporting the storage device tote in the presentation position by one of multiple tote presentation support systems disposed on a transfer station housing of the transfer station.

9. The method of claim 8, further comprising vertically arranging the tote presentation support systems with respect to each other.

10. The method of claim 7, wherein the tote presentation support system comprises first and second opposing pairs of tote support arms configured to be received by respective arm grooves defined by a tote body of a storage device tote, the method further comprising releasably locking the arm grooves into a predetermined position on the tote support arms, thereby holding the respective storage device tote in its presentation position.

11. The method of any of claim 5, further comprising:
reading a tote marking on the storage device tote; and
actuating the transfer station to move the storage device tote from the loading position to the presentation position based on the tote marking.

12. The method of claim 11, wherein the tote marking comprises at least one of a barcode and a color marking.

13. The method of claim 11, further comprising assigning the storage device tote a function property that affects the usage of the storage device tote in the storage device testing system.

14. The method of claim 13, further comprising dynamically re-assigning the function property during usage of the storage device tote in the storage device testing system.

15. The method of claim 5, further comprising loading multiple storage device totes, each housing storage devices, onto the transfer station by sequentially placing each storage device tote in the loading position on the transfer station and actuating the tote mover to move each storage device tote to the presentation position at one of the multiple presentation positions for servicing by the storage device testing system.

16. The method of claim 5, further comprising:
opening a door to an open position, the door being pivotally attached to a transfer station housing of the transfer station and configured to provide closure of a tote supply opening defined by the transfer station housing;
placing the storage device tote in a preloading position on the door, the door being configured to receive and to support a storage device tote; and
closing the door by rotating the door to a closed position, thereby placing the storage device tote in the loading position.

17. The method of claim 6, wherein actuating the tote mover comprises actuating a multi-axis actuator assembly configured to move the storage device tote between the loading position and the presentation position.

18. A transfer station for a storage device testing system, the transfer station comprising:
a transfer station housing;
multiple tote presentation support systems disposed on the transfer station housing, each tote presentation support system configured to receive and support a storage device tote in a presentation position for servicing by the storage device testing system; and
a tote mover disposed on the transfer station housing and configured to move a storage device tote between a loading position and the presentation position at one of the tote presentation support systems.

19. A transfer station for a storage device testing system, the transfer station comprising:
a transfer station housing;
multiple tote presentation support systems disposed on the transfer station housing, each tote presentation support system configured to receive and support a storage device tote in a presentation position for servicing by the storage device testing system;
a tote mover disposed on the transfer station housing; and
a tote loading support pivotally coupled to the tote mover and configured to receive and support a storage device tote, the tote loading support pivoting and moving between first and second positions;
wherein the tote mover is configured to move the tote loading support between the first position, for supporting a storage device tote in a loading position, and the second position, for supporting a storage device tote in the presentation position at one of the tote presentation support systems.

20. The transfer station of claim 18, further comprising a door pivotally attached to the transfer station housing and configured to provide closure of a tote supply opening defined by the transfer station housing, the door being configured to pivot between an open position, for receiving and supporting a storage device tote, and a closed position, for placing the storage device tote in the loading position.

21. The transfer station of claim 18, wherein the tote presentation support systems are each disposed on the same side of the transfer station housing and arranged vertically with respect to each other, each tote presentation support systems having a different elevation with respect to the others.

22. The transfer station of claim 18, wherein the tote presentation support system comprises first and second opposing pairs of tote support arms configured to be received by respective arm grooves defined by a tote body of a storage device tote.

23. The transfer station of claim 18, wherein the tote mover comprises a multi-axis actuator assembly having a vertical actuator, a horizontal actuator, and a pitch actuator.

24. The transfer station of claim 19, wherein the multi-axis actuator assembly comprises:
a first linear actuator disposed on a side wall of the transfer station housing;
a lift carriage coupled to the first linear actuator;
a second linear actuator disposed on the lift carriage and pivotally coupled to the tote loading support; and
a third linear actuator pivotally coupled to both the second linear actuator and the tote loading support, the third linear actuator configured to rotate the tote loading support.

25. The transfer station of claim 19, wherein the first position of the tote loading support is substantially horizontal and the second position of the tote loading support is substantially vertical.

26. The transfer station of claim 18, wherein the storage device tote comprises a tote body defining multiple storage device receptacles configured to each house a storage device.

27. A storage device testing system comprising:
an automated transporter;
multiple racks arranged around the automated transporter for access by the automated transporter;
multiple test slots housed by each rack, each test slot being configured to receive a storage device for testing; and
a transfer station arranged for access by the automated transporter, the transfer station comprising:
a transfer station housing;
multiple tote presentation support systems disposed on the transfer station housing, each tote presentation support system configured to receive and support a storage device tote in a presentation position for servicing by the storage device testing system; and
a tote mover disposed on the transfer station housing and configured to move a storage device tote between a loading position and the presentation position at one of the tote presentation support systems.

28. The storage device testing system of claim 27, wherein the tote presentation support system comprises first and second opposing pairs of tote support arms configured to be received by respective arm grooves defined by a tote body of a storage device tote.

29. The storage device testing system of claim 27, wherein the tote mover comprises a multi-axis actuator assembly having a vertical actuator, a horizontal actuator, and a pitch actuator.

30. The storage device testing system of claim 27, wherein the tote mover comprises:
a first linear actuator disposed on a side wall of the transfer station housing;
a lift carriage coupled to the first linear actuator;
a second linear actuator disposed on the lift carriage and pivotally coupled to a tote loading support; and
a third linear actuator pivotally coupled to both the second linear actuator and the tote loading support, the third linear actuator configured to rotate the tote loading support.

31. The storage device testing system of claim 27, wherein the transfer station further comprises a marking reader configured to read a tote marking on a received storage device tote, the tote mover being configured to move the received storage device tote between the loading position and the presentation position at one of the tote presentation support systems based on the tote marking read by the marking reader.
